(19) United States
(12) Patent Application Publication
(10) Pub. No.: US 2019/0344250 A1
(43) Pub. Date: Nov. 14, 2019

(54) PREPARATION METHOD FOR NITROGEN-DOPED CARBON-LOADED METAL MONATOMIC CATALYST

(71) Applicant: Tianjin University of Technology, Tianjin City (CN)

(72) Inventors: Lili HAN, Tianjin City (CN); Xijun LIU, Tianjin City (CN); Jun LUO, Tianjin City (CN)

(73) Assignee: Tianjin University of Technology, Tianjin City (CN)

(21) Appl. No.: 16/051,972

(22) Filed: Aug. 1, 2018

(30) Foreign Application Priority Data
May 9, 2018 (CN) 201810439437.3

(51) Int. Cl. B01J 27/24; B01J 23/30; B01J 23/28; B01J 23/72; B01J 23/26; B01J 23/745; B01J 23/06; B01J 23/75; B01J 23/34; B01J 23/22; B01J 23/755; B01J 21/06; B01J 35/00; B01J 37/04; B01J 37/03; B01J 37/02; B01J 37/08

(52) U.S. Cl. CPC B01J 27/24; B01J 37/084; B01J 23/28; B01J 23/72; B01J 23/26; B01J 23/745; B01J 23/06; B01J 23/75; B01J 23/34; B01J 23/22; B01J 23/755; B01J 21/063; B01J 35/0013; B01J 37/04; B01J 37/035; B01J 37/0236; B01J 23/30

(57) ABSTRACT

The present invention provides a preparation method for a nitrogen-doped carbon-loaded metal monatomic catalyst, including: mixing a soluble metallic salt, a hydroxylamine hydrochloride, a soluble carbon source, water, and ethanol, to obtain a mixed solution, then performing drying and precipitation, to obtain a catalyst precursor, and finally performing calcination, to obtain a nitrogen-doped carbon-loaded metal monatomic catalyst. In the present invention, the metallic salt, the hydroxylamine hydrochloride, and the carbon source are fully mixed in the solution, and after being dried, are calcined, to carbonize the carbon source, so that ammonium ions are decomposed into nitrogen-doped carbon, and meanwhile, metal atoms are loaded onto the nitrogen-doped carbon. The method is simple, and costs are low.

This application claims priority to Chinese application number 201810439437.3, filed on 9 May 2018, with a title of PREPARATION METHOD FOR NITROGEN-DOPED CARBON-LOADED METAL MONATOMIC CATALYST. The above-mentioned patent application is incorporated herein by reference in its entirety.

### TECHNICAL FIELD

The present invention relates to the field of catalyst preparation technologies, and in particular, to a preparation method for a nitrogen-doped carbon-loaded metal monatomic catalyst.

### BACKGROUND

Development of a monatomic catalyst can maximize catalytic efficiency of a metal and reduce manufacturing costs. Theoretically, a limit of dispersion of a loaded catalyst is that a metal is uniformly distributed in a monatomic form on a carrier. This not only is an ideal state of a loaded metal catalyst, but also leads catalysis science to a smaller research scale—monatomic catalysis. A monatomic catalyst is applied to oxidation and selective oxidation of CO, hydrogenation and selective hydrogenation, reduction and oxidation of NO, water-gas shift reactions, organic synthesis, steam reforming of methanol, fuel cells, photoelectric catalysis, formaldehyde oxidation, and the like. Therefore, preparing a monatomic metal catalyst becomes a key breakthrough to researchers.

Currently, preparation methods for a monatomic catalyst include a coprecipitation method, an impregnation method, an atomic layer deposition method, a reverse Ostwald ripening method, a gradual reduction method, and a solid phase fusion method. However, problems, such as complex procedures, necessity of pickling, and high costs, exist in the methods. Therefore, it is required to provide a simple general method for synthesizing a monatomic catalyst.

### SUMMARY

An objective of the present invention is to provide a preparation method for a nitrogen-doped carbon-loaded metal monatomic catalyst. The method provided in the present invention is simple and is applicable to synthesis of various monatomic catalysts.

The present invention provides a preparation method for a nitrogen-doped carbon-loaded metal monatomic catalyst, including the following steps:

(1) mixing a soluble metallic salt, hydroxylamine hydrochloride, a soluble carbon source, water, and ethanol, to obtain a mixed solution;

(2) performing drying and precipitation on the mixed solution obtained in step (1), to obtain a catalyst precursor; and

(3) calcining the catalyst precursor obtained in step (2), to obtain a nitrogen-doped carbon-loaded metal monatomic catalyst.

Preferably, in step (1), a mole ratio of the soluble metallic salt to the hydroxylamine hydrochloride is (0.001-0.01):(0.001-1).

Preferably, in step (1), a mole ratio of the soluble metallic salt to the soluble carbon source is 1:(3-5).

Preferably, in step (1), a ratio of an amount of substance of the soluble metallic salt to a volume of the water is (0.001-0.01) mol:1L.

Preferably, in step (1), a ratio of an amount of substance of the soluble metallic salt to a volume of the ethanol is (0.001-0.01) mol:1L.

Preferably, a metal element in the soluble metallic salt includes one or more of transition metal elements and post-transition metal elements.

Preferably, the soluble carbon source includes carbohydrate.

Preferably, in step (2), a temperature for the drying and precipitation ranges from 25-95° C.

Preferably, in step (3), the calcination is performed in an inert atmosphere or a vacuum.

Preferably, in step (3), a temperature for the calcination ranges from 500-800° C., and a time for the calcination ranges from 0.5-8 h.

The present invention provides a preparation method for a nitrogen-doped carbon-loaded metal monatomic catalyst, including: mixing a soluble metallic salt, a hydroxylamine hydrochloride, a soluble carbon source, water, and ethanol, to obtain a mixed solution, then performing drying and precipitation, to obtain a catalyst precursor, and finally performing calcination, to obtain a nitrogen-doped carbon-loaded metal monatomic catalyst. In the present invention, the metallic salt, the hydroxylamine hydrochloride, and the carbon source are fully mixed in the solution, and after being dried, are calcined, to carbonize the carbon source, so that ammonium ions are decomposed into nitrogen-doped carbon, and meanwhile, metal atoms are loaded onto the nitrogen-doped carbon. The method is simple, and costs are low. The experimental results show that the method provided by the present invention can be used for preparing various metal monatomic catalysts.

### BRIEF DESCRIPTION OF THE DRAWINGS

FIG. 1 is a test diagram of a nitrogen-doped carbon-loaded metal monatomic catalyst prepared according to Embodiment 1;

FIG. 2 is a test diagram of a nitrogen-doped carbon-loaded metal monatomic catalyst prepared according to Embodiment 2;

FIG. 3 is a test diagram of a nitrogen-doped carbon-loaded metal monatomic catalyst prepared according to Embodiment 3;

FIG. 4 is a test diagram of a nitrogen-doped carbon-loaded metal monatomic catalyst prepared according to Embodiment 4;

FIG. 5 is a test diagram of a nitrogen-doped carbon-loaded metal monatomic catalyst prepared according to Embodiment 5;

FIG. 6 is a test diagram of a nitrogen-doped carbon-loaded metal monatomic catalyst prepared according to Embodiment 6;

FIG. 7 is a test diagram of a nitrogen-doped carbon-loaded metal monatomic catalyst prepared according to Embodiment 7;

FIG. 8 is a test diagram of a nitrogen-doped carbon-loaded metal monatomic catalyst prepared according to Embodiment 8;

FIG. 9 is a test diagram of a nitrogen-doped carbon-loaded metal monatomic catalyst prepared according to Embodiment 9;

FIG. 10 is a test diagram of a nitrogen-doped carbon-loaded metal monatomic catalyst prepared according to Embodiment 10; and

FIG. 11 is a test diagram of a nitrogen-doped carbon-loaded metal monatomic catalyst prepared according to Embodiment 11.

In the figures, a is a high-angle annular dark field image of a scanning transmission electron microscope, b is a diagram of distribution of an X-ray energy dispersive spectroscopy of a metal element, c is an atomic-resolution high-angle annular dark field image of a scanning transmission electron microscope, and d is an X-ray diffraction pattern.

### DETAILED DESCRIPTION

The present invention provides a preparation method for a nitrogen-doped carbon-loaded metal monatomic catalyst, including the following steps:

(1) A soluble metallic salt, hydroxylamine hydrochloride, a soluble carbon source, water, and ethanol were mixed to obtain a mixed solution.

(2) Drying and precipitation were performed on the mixed solution obtained in step (1), to obtain a catalyst precursor.

(3) The catalyst precursor obtained in step (2) was calcined, to obtain a nitrogen-doped carbon-loaded metal monatomic catalyst.

In the present invention, the soluble metallic salt, the hydroxylamine hydrochloride, the soluble carbon source, the water, and the ethanol were mixed, to obtain the mixed solution. In the present invention, a mole ratio of the soluble metallic salt to the hydroxylamine hydrochloride is preferably (0.001-0.01):(0.001-1), more preferably (0.002-0.008):(0.01-0.5), and most preferably (0.004-0.006):(0.05-0.1).

In the present invention, a mole ratio of the soluble metallic salt to the soluble carbon source is preferably 1:(3-5), and more preferably 1:4.

In the present invention, a ratio of an amount of substance of the soluble metallic salt to a volume of the water is preferably (0.001-0.01) mol:1L, more preferably (0.002-0.008) mol:1L, and most preferably (0.004-0.006) mol:1L.

In the present invention, a ratio of an amount of substance of the soluble metallic salt to a volume of the ethanol is preferably (0.001-0.01) mol:1L, more preferably (0.002-0.008) mol:1L, and most preferably (0.004-0.006) mol:1L.

In the present invention, a metal element in the soluble metallic salt preferably includes one or more of transition metal elements and post-transition metal elements, and more preferably includes one or more of W, Mo, Cu, Cr, Fe, Zn, Co, Mn, V, Ni, and Ti. The present invention does not specially define the type of the soluble metallic salt, provided that a soluble salt of a corresponding metal well-known to a person skilled in the art is used. In the present invention, the soluble metallic salt is preferably a water-soluble metallic salt.

In the present invention, when a metal single-atom of the nitrogen-doped carbon-loaded metal monatomic catalyst is W, the soluble metallic salt preferably includes ammonium tungstate; when the metal single-atom of the nitrogen-doped carbon-loaded metal monatomic catalyst is Mo, the soluble metallic salt preferably includes one or more of ammonium molybdate, molybdenyl acetylacetonate, and phosphomolybdic acid hydrate; when the metal single-atom of the nitrogen-doped carbon-loaded metal monatomic catalyst is Cu, the soluble metallic salt preferably includes one or more of copper chloride, cupric acetate, and copper nitrate; when the metal single-atom of the nitrogen-doped carbon-loaded metal monatomic catalyst is Cr, the soluble metallic salt preferably includes one or more of chromium acetate, and ammonium chromate; when the metal single-atom of the nitrogen-doped carbon-loaded metal monatomic catalyst is Fe, the soluble metallic salt preferably includes one or more of ferrous gluconate, ammonium ferric citrate, and ferric acetylacetonate; when the metal single-atom of the nitrogen-doped carbon-loaded metal monatomic catalyst is Zn, the soluble metallic salt preferably includes one or more of zinc acetate, zinc chloride, and zinc gluconate; when the metal single-atom of the nitrogen-doped carbon-loaded metal monatomic catalyst is Co, the soluble metallic salt preferably includes one or more of cobalt acetate tetrahydrate, cobalt chloride, and cobalt nitrate; when the metal single-atom of the nitrogen-doped carbon-loaded metal monatomic catalyst is Mn, the soluble metallic salt preferably includes one or more of manganese nitrate, manganese acetate, and manganese chloride; when the metal single-atom of the nitrogen-doped carbon-loaded metal monatomic catalyst is V, the soluble metallic salt preferably includes ammonium vanadate; when the metal single-atom of the nitrogen-doped carbon-loaded metal monatomic catalyst is Ni, the soluble metallic salt preferably includes one or more of nickel nitrate, nickel chloride, and nickel acetate; and when the metal single-atom of the nitrogen-doped carbon-loaded metal monatomic catalyst is Ti, the soluble metallic salt preferably includes titanium chloride and/or titanyl sulfate.

In the present invention, the soluble carbon source is preferably a water-soluble carbon source, more preferably includes carbohydrate, and most preferably includes glucose and/or sucrose. In the present invention, the water is preferably deionized water. In the present invention, the water and the ethanol serve as dispersion mediums, and can improve dispersion of the soluble metallic salt, the hydroxylamine hydrochloride, and the soluble carbon source, to obtain a homogeneous mixture mixed in a molecular state.

The present invention does not specially define the operation of mixing the soluble metallic salt, the hydroxylamine hydrochloride, the soluble carbon source, the water, and the ethanol, provided that a uniformly mixed solution can be obtained. In the present invention, preferably, the soluble metallic salt, the hydroxylamine hydrochloride, and the water were mixed, to obtain an aqueous solution, and then, the ethanol and the soluble carbon source were sequentially added, to obtain a mixed solution.

In the present invention, the soluble metallic salt, mixing of the hydroxylamine hydrochloride, and the water and mixing of the aqueous solution, the ethanol, and the soluble carbon source were preferably independently carried out under an ultrasonic condition. The present invention does not specially define a frequency and a time of ultrasound, provided that an ultrasonic mixing operation well-known to a person skilled in the art is used. In the present invention, the ultrasound can further improve mixing of respective components.

After the mixed solution was obtained, in the present invention, drying and precipitation were performed on the mixed solution, to obtain a catalyst precursor. In the present invention, a temperature for the drying and precipitation preferably ranges from 25-95° C., more preferably ranges from 30-80° C., and most preferably ranges from 40-80° C. In the present invention, in the process of the drying and precipitation, the water and the ethanol were volatilized, to obtain a solid mixture.

After the catalyst precursor was obtained, in the present invention, the catalyst precursor was calcined, to obtain a nitrogen-doped carbon-loaded metal monatomic catalyst. In the present invention, the calcination was preferably performed in an inert atmosphere or a vacuum. In the present invention, a temperature for the calcination preferably ranges from 500-800° C., more preferably ranges from 600-700° C.; and a time for the calcination preferably ranges from 0.5-8 h, more preferably ranges from 1-6 h, and most preferably ranges from 3-5 h. In the present invention, the calcination was performed, the carbon source was carbonized, ammonium ions were decomposed into nitrogen-doped carbon, and the metallic salt was decomposed into metal atoms loaded on the nitrogen-doped carbon.

After the calcination was completed, in the present invention, preferably, a product of the calcination was cooled and ground, to obtain the nitrogen-doped carbon-loaded metal monatomic catalyst. The present invention does not specially define operations of the cooling and grinding, provided that cooling and grinding technical solutions well-known to a person skilled in the art are used. In the present invention, a particle size of a ground product is preferably below 1 μm.

To further describe the present invention, the preparation method for a nitrogen-doped carbon-loaded metal monatomic catalyst provided by the present invention is described below in detail with reference to examples, but the examples should not be interpreted as limitations to the protection scope of the present invention.

### Embodiment 1:

Synthesis of a W monatomic catalyst: Ammonium tungstate, hydroxylamine hydrochloride, and glucose were used as precursors, and steps of dissolution, precipitation, calcination steps were performed for analysis, specifically, as follows:

(1) 0.0111 g of ammonium tungstate and 0.69 g of hydroxylamine hydrochloride were weighed and placed into a beaker, 40 ml of deionized water was added, they were ultrasonically dissolved for five minutes, then, 40 ml of alcohol was added, subsequently, 0.0544 g of anhydrous glucose was added, and the mixture was ultrasonically dissolved and then was dried in an oven at a temperature of 70 ° C.

(2) A dried sample was taken out, placed into a porcelain boat, transferred into a vacuum tubular furnace, and protected by feeding high purity argon at a rate of 50 ml/minute, the vacuum tubular furnace was heated at a rate of 5° C./minute from the room temperature to 600° C., and heat preservation was performed for 4 h.

(3) The vacuum tubular furnace was cooled to the room temperature, the sample was taken out and ground with a mortar, and synthesis of the W monatomic catalyst was completed.

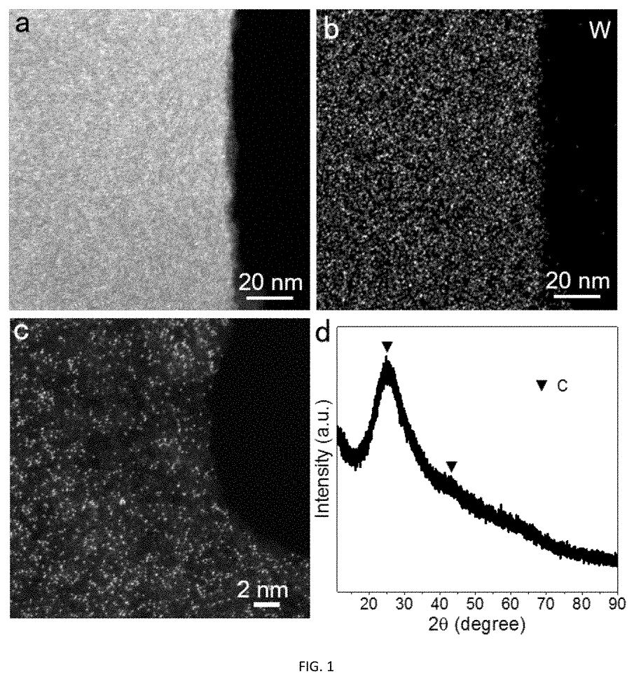

The nitrogen-doped carbon-loaded metal monatomic catalyst prepared in this Embodiment is shown in FIG. 1. FIG. 1a is a scanning transmission dark field image of Embodiment 1, from which it could be learned that no notable agglomerated particle appears. From FIG. 1b, it could be learned that W element is uniformly distributed on a substrate. FIG. 1c is an atomic resolution high-angle annular dark field image, from which it could be learned that W single-atoms are scattered across the substrate. In FIG. 1d, except for X-ray diffraction peaks of amorphous carbon, no diffraction peak position of another crystal appears. The results indicate that single W atoms are scattered across the substrate, proving successful synthesis of the W monatomic catalyst.

### Embodiment 2:

Synthesis of a Mo monatomic catalyst: Synthesis steps thereof are the same as those of the synthesis of the W monatomic catalyst in Embodiment 1 except for that 0.0111 g of ammonium tungstate is replaced with 0.0155 g of ammonium molybdate, and the temperature of the vacuum tubular furnace is increased to 650° C. instead of 600° C.

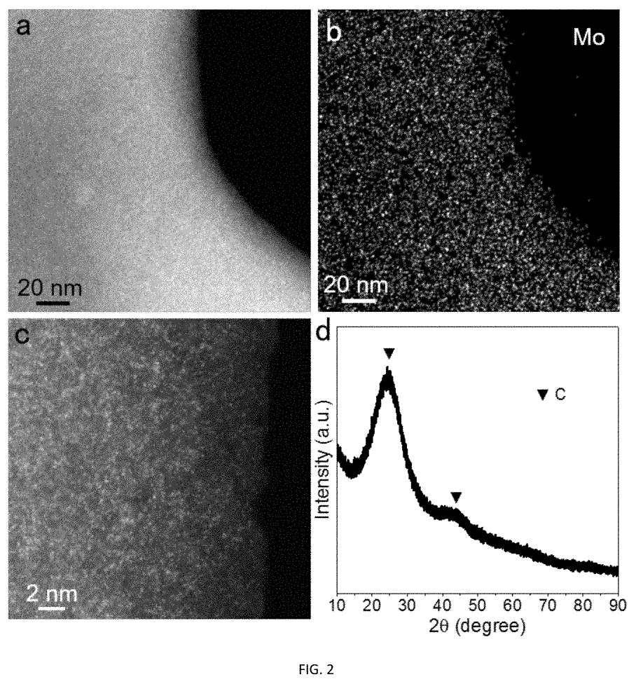

The nitrogen-doped carbon-loaded metal monatomic catalyst prepared in this Embodiment is shown in FIG. 2. FIG. 2a is a scanning transmission dark field image of Embodiment 2, from which it could be learned that no notable agglomerated particle appears. From FIG. 2b, it could be learned that Mo element is uniformly distributed on a substrate. FIG. 2c is an atomic resolution high-angle annular dark field image, from which it could be obviously learned that Mo single-atoms are scattered across the substrate. In FIG. 2d, except for X-ray diffraction peaks of amorphous carbon, no diffraction peak position of another crystal appears. The results indicate that single Mo atoms are scattered across the substrate, proving successful synthesis of the Mo monatomic catalyst.

### Embodiment 3:

Synthesis of a Cu monatomic catalyst: Synthesis steps thereof are the same as those of the synthesis of the W monatomic catalyst in Embodiment 1 except for that 0.0111 g of ammonium tungstate is replaced with 0.0059 g of copper chloride.

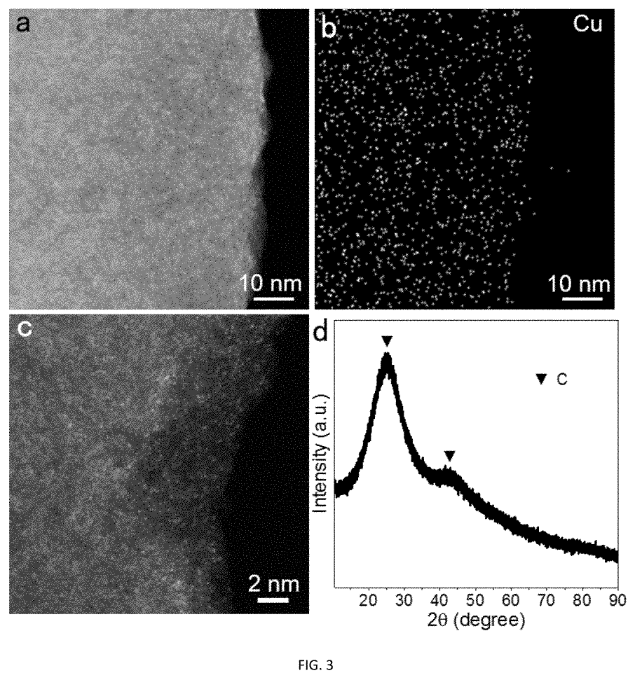

The nitrogen-doped carbon-loaded metal monatomic catalyst prepared in this Embodiment is shown in FIG. 3. FIG. 3a is a scanning transmission dark field image of Embodiment 3, from which it could be learned that no notable agglomerated particle appears. From FIG. 3b, it could be learned that Cu element is uniformly distributed on a substrate. FIG. 3c is an atomic resolution high-angle annular dark field image, from which it could be obviously learned that Cu single-atoms are distributed on the substrate. In FIG. 3d, except for X-ray diffraction peaks of amorphous carbon, no diffraction peak position of another crystal appears. The results indicate that single Cu atoms are scattered across the substrate, proving successful synthesis of the Cu monatomic catalyst.

### Embodiment 4:

Synthesis of a Cr monatomic catalyst: Synthesis steps thereof are the same as those of the synthesis of the W monatomic catalyst in Embodiment 1 except for that 0.0111 g of ammonium tungstate is replaced with 0.0201 g of chromium acetate.

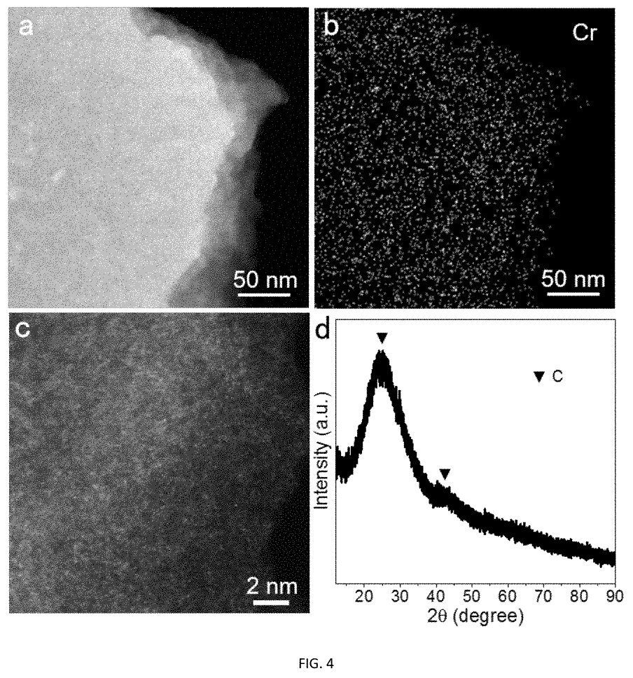

The nitrogen-doped carbon-loaded metal monatomic catalyst prepared in this Embodiment is shown in FIG. 4. FIG. 4a is a scanning transmission dark field image of Embodiment 4, from which it could be learned that no notable agglomerated particle appears. From FIG. 4b, it could be learned that Cr element is uniformly distributed on a substrate. FIG. 4c is an atomic resolution high-angle annular dark field image, from which it could be obviously learned that Cr single-atoms are distributed on the substrate. In FIG. 4d, except for X-ray diffraction peaks of amorphous carbon, no diffraction peak position of another crystal appears. The results indicate that single Cr atoms are scattered across the substrate, proving successful synthesis of the Cr monatomic catalyst.

### Embodiment 5:

Synthesis of a Fe monatomic catalyst: Synthesis steps thereof are the same as those of the synthesis of the W monatomic catalyst in Embodiment 1 except for that 0.0111 g of ammonium tungstate is replaced with 0.02116 g of ferrous gluconate.

The nitrogen-doped carbon-loaded metal monatomic catalyst prepared in this Embodiment is shown in

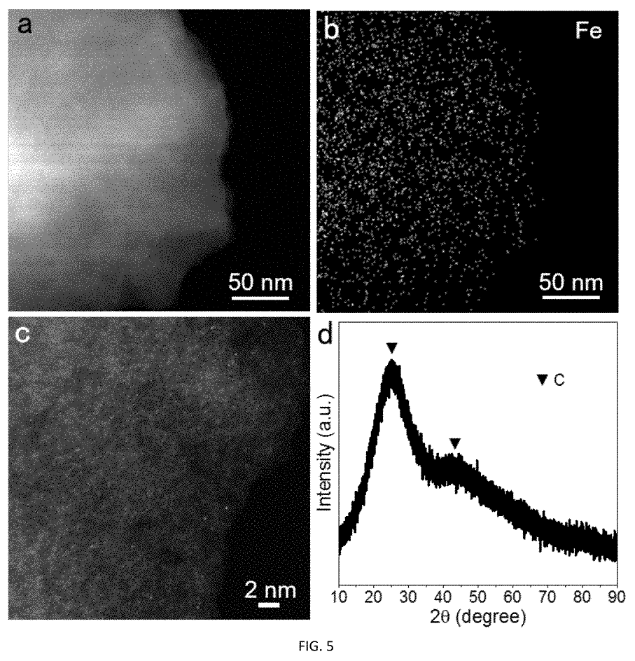

FIG. 5. FIG. 5a is a scanning transmission dark field image of Embodiment 5, from which it could be learned that no notable agglomerated particle appears. From FIG. 5b, it could be learned that Fe element is uniformly distributed on a substrate. FIG. 5c is an atomic resolution high-angle annular dark field image, from which it could be obviously learned that Fe single-atoms are distributed on the substrate. In FIG. 5d, except for X-ray diffraction peaks of amorphous carbon, no diffraction peak position of another crystal appears. The results indicate that single Fe atoms are scattered across the substrate, proving successful synthesis of the Fe monatomic catalyst.

### Embodiment 6

Synthesis of a Zn monatomic catalyst: Synthesis steps thereof are the same as those of the synthesis of the W monatomic catalyst in Embodiment 1 except for that 0.0111 g of ammonium tungstate is replaced with 0.1926 g of zinc acetate.

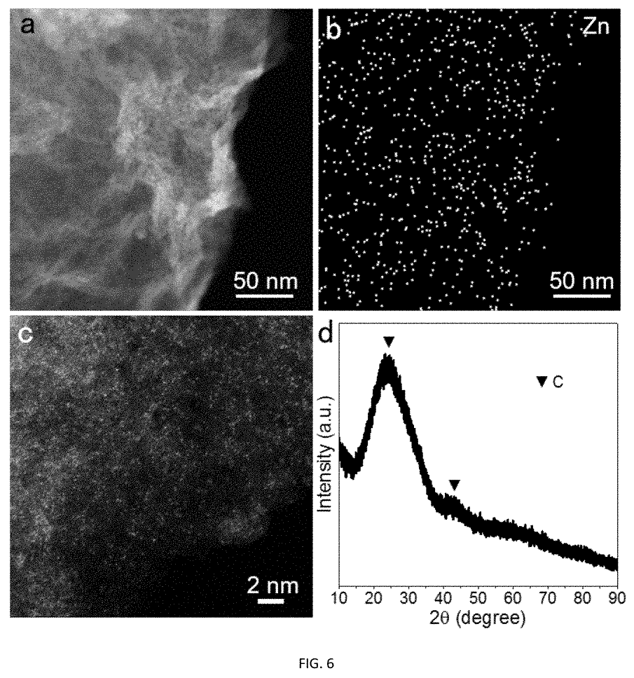

The nitrogen-doped carbon-loaded metal monatomic catalyst prepared in this Embodiment is shown in FIG. 6. FIG. 6a is a scanning transmission dark field image of Embodiment 6, from which it could be learned that no notable agglomerated particle appears. From FIG. 6b, it could be learned that Zn element is uniformly distributed on a substrate. FIG. 6c is an atomic resolution high-angle annular dark field image, from which it could be obviously learned that Zn single-atoms are distributed on the substrate. In FIG. 6d, except for X-ray diffraction peaks of amorphous carbon, no diffraction peak position of another crystal appears. The results indicate that single Zn atoms are scattered across the substrate, proving successful synthesis of the Zn monatomic catalyst.

### Embodiment 7

Synthesis of a Co monatomic catalyst: Synthesis steps thereof are the same as those of the synthesis of the W monatomic catalyst in Embodiment 1 except for that 0.0111 g of ammonium tungstate is replaced with 0.0109 g of cobalt acetate tetrahydrate.

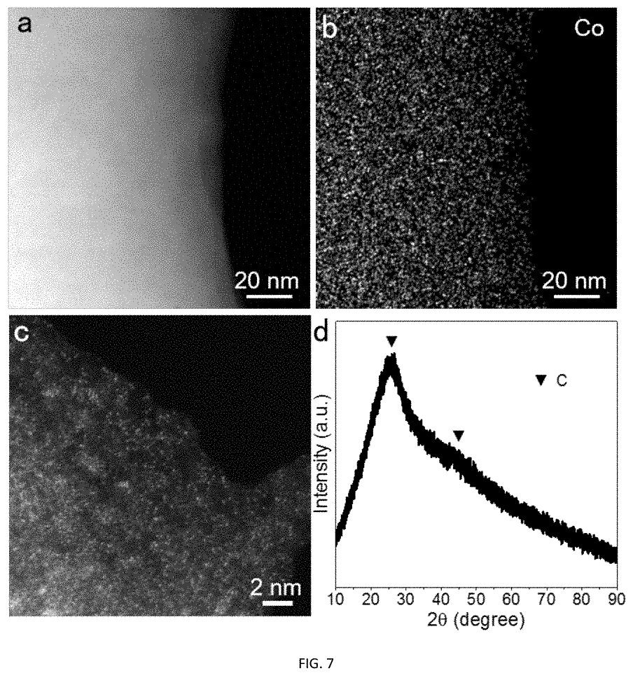

The nitrogen-doped carbon-loaded metal monatomic catalyst prepared in this Embodiment is shown in FIG. 7. FIG. 7a is a scanning transmission dark field image of Embodiment 7, from which it could be learned that no notable agglomerated particle appears. From FIG. 7b, it could be learned that Co element is uniformly distributed on a substrate. FIG. 7c is an atomic resolution high-angle annular dark field image, from which it could be obviously learned that Co single-atoms are distributed on the substrate. In FIG. 7d, except for X-ray diffraction peaks of amorphous carbon, no diffraction peak position of another crystal appears. The results indicate that single Co atoms are scattered across the substrate, proving successful synthesis of the Co monatomic catalyst.

### Embodiment 8

Synthesis of a Mn monatomic catalyst: Synthesis steps thereof are the same as those of the synthesis of the W monatomic catalyst in Embodiment 1 except for that 0.0111 g of ammonium tungstate is replaced with 0.0079 g of manganese nitrate.

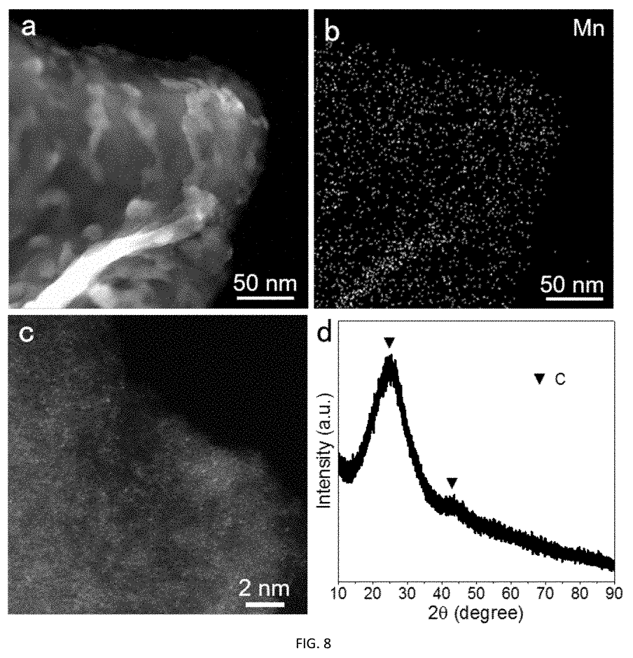

The nitrogen-doped carbon-loaded metal monatomic catalyst prepared in this Embodiment is shown in FIG. 8. FIG. 8a is a scanning transmission dark field image of Embodiment 8. Although there are areas having inconsistent contrasts, it could be learned from FIG. 8b that Mn element is uniformly distributed on a substrate. I could be learned from FIG. 8c that Mn single-atoms are distributed on the substrate. In FIG. 8d, except for X-ray diffraction peaks of amorphous carbon, no diffraction peak position of another crystal appears. The results indicate that single Mn atoms are scattered across the substrate, proving successful synthesis of the Mn monatomic catalyst.

### Embodiment 9

Synthesis of a V monatomic catalyst: Synthesis steps thereof are the same as those of the synthesis of the W monatomic catalyst in Embodiment 1 except for that 0.0111 g of ammonium tungstate is replaced with 0.0051 g of ammonium vanadate.

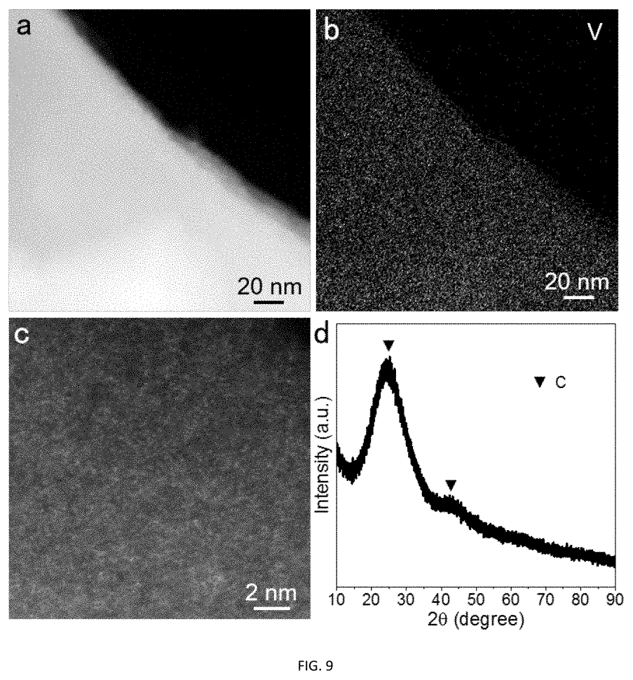

The nitrogen-doped carbon-loaded metal monatomic catalyst prepared in this Embodiment is shown in FIG. 9. FIG. 9a is a scanning transmission dark field image of Embodiment 9, from which it could be learned that no notable agglomerated particle appears. From FIG. 9b, it could be learned that V element is uniformly distributed on a substrate. FIG. 9c is an atomic resolution high-angle annular dark field image, from which it could be obviously learned that V single-atoms are distributed on the substrate. In FIG. 9d, except for X-ray diffraction peaks of amorphous carbon, no diffraction peak position of another crystal appears. The results indicate that single V atoms are scattered across the substrate, proving successful synthesis of the V monatomic catalyst.

### Embodiment 10

Synthesis of a Ni monatomic catalyst: Synthesis steps thereof are the same as those of the synthesis of the W monatomic catalyst in Embodiment 1 except for that 0.0111 g of ammonium tungstate is replaced with 0.0109 g of cobalt acetate tetrahydrate.

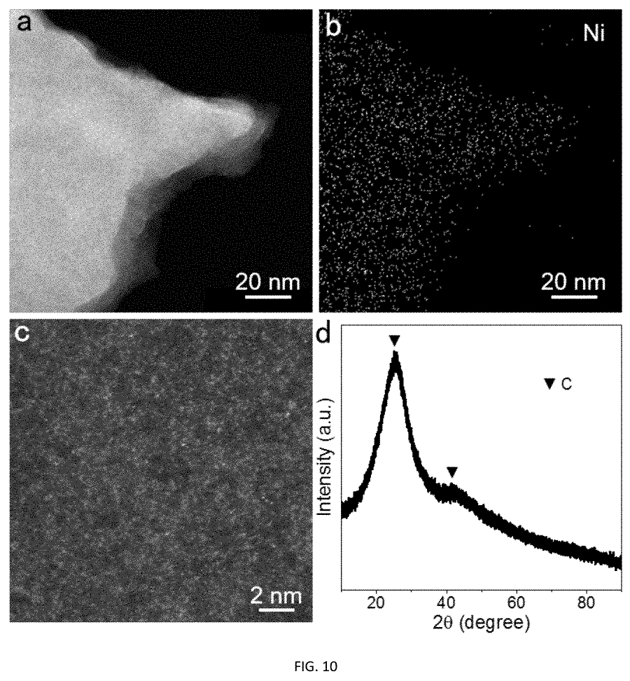

The nitrogen-doped carbon-loaded metal monatomic catalyst prepared in this Embodiment is shown in FIG. 10. FIG. 10a is a scanning transmission dark field image of Embodiment 10, from which it could be learned that no notable agglomerated particle appears. From FIG. 10b, it could be learned that Ni element is uniformly distributed on a substrate. FIG. 10c is an atomic resolution high-angle annular dark field image, from which it could be obviously learned that Ni single-atoms are distributed on the substrate. In FIG. 10d, except for X-ray diffraction peaks of amorphous carbon, no diffraction peak position of another crystal appears. The results indicate that single Ni atoms are scattered across the substrate, proving successful synthesis of the Ni monatomic catalyst.

### Embodiment 11

Synthesis of a Ti monatomic catalyst: Synthesis steps thereof are the same as those of the synthesis of the W monatomic catalyst in Embodiment 1 except for that 0.0111 g of ammonium tungstate is replaced with 0.0083 g of titanium chloride.

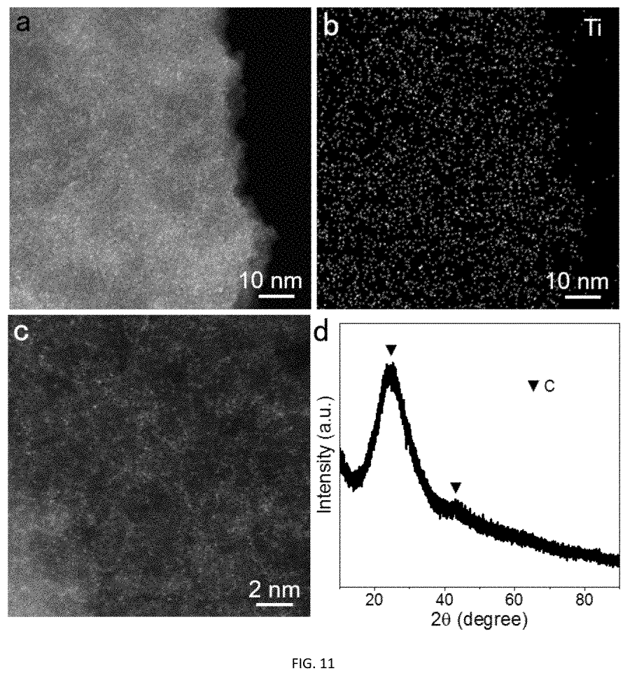

The nitrogen-doped carbon-loaded metal monatomic catalyst prepared in this Embodiment is shown in FIG. 11. FIG. 11a is a scanning transmission dark field image of Embodiment 11, from which it could be learned that no notable agglomerated particle appears. From FIG. 11b, it could be learned that Ti element is uniformly distributed on a substrate. FIG. 11c is an atomic resolution high-angle annular dark field image, from which it could be obviously learned that Ti single-atoms are distributed on the substrate. In FIG. 11d, except for X-ray diffraction peaks of amorphous carbon, no diffraction peak position of another crystal appears. The results indicate that single Ti atoms are scattered across the substrate, proving successful synthesis of the Ti monatomic catalyst.

It could be learned from the foregoing examples that the method provided by the present invention is simple and applicable to synthesis of various monatomic catalysts.

The foregoing descriptions are merely preferred implementations of the present invention rather than limitations on the present invention in any form. It should be pointed out that for a person of ordinary skilled in the art, several improvements and modifications may further be made without departing from the principle of the present invention, and the improvements and modifications should also be considered to fall within the protection scope of the present invention.

1-10. (canceled)

11. A preparation method for a nitrogen-doped carbon-loaded metal monatomic catalyst, comprising the following steps:
(1) mixing a soluble metallic salt, hydroxylamine hydrochloride, a soluble carbon source, water, and ethanol, to obtain a mixed solution;
(2) performing drying and precipitation on the mixed solution obtained in step (1), to obtain a catalyst precursor; and
(3) calcining the catalyst precursor obtained in step (2), to obtain a nitrogen-doped carbon-loaded metal monatomic catalyst.

12. The preparation method according to claim 11, wherein in step (1), a mole ratio of the soluble metallic salt to the hydroxylamine hydrochloride is (0.001-0.01):(0.001-1).

13. The preparation method according to claim 11, wherein in step (1), a mole ratio of the soluble metallic salt to the soluble carbon source is 1:(3-5).

14. The preparation method according to claim 11, wherein in step (1), a ratio of an amount of substance of the soluble metallic salt to a volume of the water is (0.001-0.01) mol:1L.

15. The preparation method according to claim 11, wherein in step (1), a ratio of an amount of substance of the soluble metallic salt to a volume of the ethanol is (0.001-0.01) mol:1L.

16. The preparation method according to claim 11, wherein a metal element in the soluble metallic salt comprises one or more of transition metal elements and post-transition metal elements.

17. The preparation method according to claim 12, wherein a metal element in the soluble metallic salt comprises one or more of transition metal elements and post-transition metal elements.

18. The preparation method according to claim 13, wherein a metal element in the soluble metallic salt comprises one or more of transition metal elements and post-transition metal elements.

19. The preparation method according to claim 14, wherein a metal element in the soluble metallic salt comprises one or more of transition metal elements and post-transition metal elements.

20. The preparation method according to claim 15, wherein a metal element in the soluble metallic salt comprises one or more of transition metal elements and post-transition metal elements.

21. The preparation method according to claim 11, wherein the soluble carbon source comprises carbohydrate.

22. The preparation method according to claim 12, wherein the soluble carbon source comprises carbohydrate.

23. The preparation method according to claim 13, wherein the soluble carbon source comprises carbohydrate.

24. The preparation method according to claim 14, wherein the soluble carbon source comprises carbohydrate.

25. The preparation method according to claim 15, wherein the soluble carbon source comprises carbohydrate.

26. The preparation method according to claim 11, wherein in step (2), a temperature for the drying and precipitation ranges from 25-95° C.

27. The preparation method according to claim 11, wherein in step (3), the calcination is performed in an inert atmosphere or a vacuum.

28. The preparation method according to claim 11, wherein in step (3), a temperature for the calcination ranges from 500-800° C., and a time for the calcination ranges from 0.5-8 h.

29. The preparation method according to claim 27, wherein in step (3), a temperature for the calcination ranges from 500-800° C., and a time for the calcination ranges from 0.5-8 h.
